(19) United States
(12) Patent Application Publication
(10) Pub. No.: US 2005/0274806 A1
(43) Pub. Date: Dec. 15, 2005

(54) System, method and article for enhancing aiming in machine-readable symbol readers, such as barcode readers

(75) Inventor: Michael W. Dant, Cedar Rapids, IA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Intermec IP Corp., Woodland Hills, CA (US)

(21) Appl. No.: 11/141,251

(22) Filed: May 31, 2005

Related U.S. Application Data
(60) Provisional application No. 60/577,451, filed on Jun. 5, 2004.

(51) Int. Cl. G06K 7/10; G06K 9/24

(52) U.S. Cl. 235/462.21

(57) ABSTRACT

A reader for reading machine-readable symbols such as barcode, area or matrix code, or stack code symbols employs an aiming beam which may continue to provide an indication of an orientation of a field-of-view of the reader for a set interval following a successful decode of a machine-readable symbol. This provides a more intuitive and efficient user interface, allowing a user to quickly aim at a next symbol to be acquired, without inadvertently acquiring and/or decoding an unintended symbol. This may also reduce the number of user actions required to operate the reader, and may simplify the triggering mechanism interface.

### CROSS-REFERENCE TO RELATED APPLICATIONS

The application claims benefit under 35 U.S.C. § 119(e) to U.S. provisional patent application Ser. No. 60/577,451, filed Jun. 5, 2004.

### BACKGROUND OF THE INVENTION

1. Field of the Invention

The disclosure generally relates to the field of automatic data collection (ADC), and more particularly to machine-readable symbol readers, for example, readers for reading machine-readable symbols such as barcode, area or matrix code and/or stacked code symbols.

2. Description of the Related Art

From a user's point of view, one of the most difficult parts to decoding a machine-readable symbol captured with an imager or other machine-readable symbol reader is aiming the reader at the desired symbol. To aid in this process the machine-readable symbol reader may include a pointer or aiming device that produces a visible aiming beam in response to the user activating a user input device, for example when a user presses a scan trigger. The aiming device is typically turned OFF to prevent interfering with the capture of the machine-readable symbol. Once the machine-readable symbol is decoded, or the trigger is released, the aiming device is turned OFF.

There are two problems presented by this scenario. First, the user has to press the trigger before the aimer comes on, which means that if the user happens to point at an unintended machine-readable symbol between the time the user presses the trigger and aims the reader at the desired machine-readable symbol, the unintended machine-readable symbol will be decoded. The second problem is that if multiple machine-readable symbols are being acquired and decoded in succession, the aiming device will turn OFF just when it is really desired.

A more intuitive approach to identifying target machine-readable symbols and/or acquiring the same would be desirable.

### BRIEF SUMMARY OF THE INVENTION

It is conceived that it would be very advantageous when scanning multiple machine-readable symbols, to have the aiming device active immediately after the previous machine-readable symbol is decoded, or the scan trigger is released, so that the user can easily move on to the next machine-readable symbol without having to depress the trigger again until the reader is aimed at the next machine-readable symbol.

Described herein is a method making it easier to aim a machine-readable symbol reader at machine-readable symbols, such as barcode or other symbologies, and therefore making it quicker and more efficient to capture and decode such symbols. This is done by arranging to have the aimer on after a machine-readable symbol is decoded or the scan trigger is released. The “sticky” aimer is then turned OFF automatically after a specified length of time. This allows the user to immediately begin aiming at the next machine-readable symbol even after decoding the first machine-readable symbol, and without pressing the scan trigger again, after the scan trigger has been released during the first reading operation.

The “sticky” aimer addresses the aiming problem by having the aimer on for a specified length of time after the previous machine-readable symbol is decoded or the scan trigger is released. This means that the aimer is ON more frequently and more consistently and makes for a more intuitive user experience. The user is able to move to the second or third or fourth machine-readable symbols without having to press the scan trigger until the reader is already aimed and ready to decode. This avoids scanning unintended machine-readable symbols, and makes it easier to find the next machine-readable symbol with a minimum of effort on the user's part. Testers have found that the “sticky” aimer is much more intuitive and user friendly than previous aimer approaches.

In one aspect, a method of operating a machine-readable symbol reader comprises: projecting an aiming beam from the machine-readable symbol reader in a direction generally aligned with a field-of-view of the machine-readable symbol reader; determining whether an elapsed time following a successful decoding of an acquired first machine-readable symbol exceeds an elapsed time threshold; and continually projecting the aiming beam from the machine-readable symbol reader until the elapsed time is determined to exceed the elapsed time threshold.

In another aspect, a processor-readable medium stores instructions for operating a machine-readable symbol reader by: projecting an aiming beam from the machine-readable symbol reader in a direction generally aligned with a field-of-view of the machine-readable symbol reader; determining whether an elapsed time following a successful decoding of an acquired first machine-readable symbol exceeds an elapsed time threshold; and continually projecting the aiming beam from the machine-readable symbol reader until the elapsed time is determined to exceed the elapsed time threshold.

In yet another aspect, a method of operating a machine readable symbol reader comprises in response to a first activation of a user input device, projecting an aiming beam from the machine-readable symbol reader in a direction generally aligned with a field-of-view of the machine-readable symbol reader; acquiring a first machine-readable symbol in the field-of-view of the machine-readable symbol reader; attempting to decode the acquired first machine-readable symbol; determining that the attempt to decode the acquired first machine-readable symbol was successful; determining whether an elapsed time following the successful decode of the acquired first machine-readable symbol exceeds an elapsed time threshold; and projecting the aiming beam from the machine-readable symbol reader if it is determined that the elapsed time does not exceed the elapsed time threshold.

In a further aspect, a machine-readable symbol reader comprises: a housing; an optoelectronic detector received in the housing and having a field-of-view extending from the housing; an aiming subsystem carried by the housing an operable to selectively project an aiming beam from the machine-readable symbol reader in a direction generally aligned with the field-of-view of the optoelectronic detector; a first trigger operable in response to a first activation to cause the aiming system to project the aiming beam from the machine-readable symbol reader and operable in response to a second activation while the aiming beam projects from the machine-readable symbol reader to cause the acquisition of an electronic representation of machine-readable symbols for decoding; and a control subsystem received in the housing and coupled to control the aiming subsystem based at least in part on signals generated by the first and the second activation of the first trigger.

### BRIEF DESCRIPTION OF THE DRAWING

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram showing a machine-readable symbol reader illuminating a machine-readable symbol with an aiming beam, according to one illustrated embodiment.

FIG. 2 is a functional block diagram of the machine-readable symbol reader of FIG. 1, including an imaging subsystem, control subsystem, aiming beam subsystem, and optional illumination subsystem according to one illustrated embodiment.

FIG. 3 is a flowchart showing a method of operating the machine-readable symbol reader of FIGS. 1 and 2 according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with machine-readable symbol readers, imaging detectors, processors, and illumination systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

The present disclosure is directed to an aimer that continues to illuminate after a successful decode of an acquired machine-readable symbol. The concept termed herein as a “sticky” aimer, is implemented by doing almost the exact opposite of what is currently done with the aimer after a successful decode or when the user releases the scan trigger. Instead of the aimer being in an OFF state (i.e., not illuminating) after a decode or after release of the trigger, the aimer is in an ON (i.e., illuminating). The sticky aimer then stays ON until the user activates the scan trigger or a user-definable timeout period elapses.

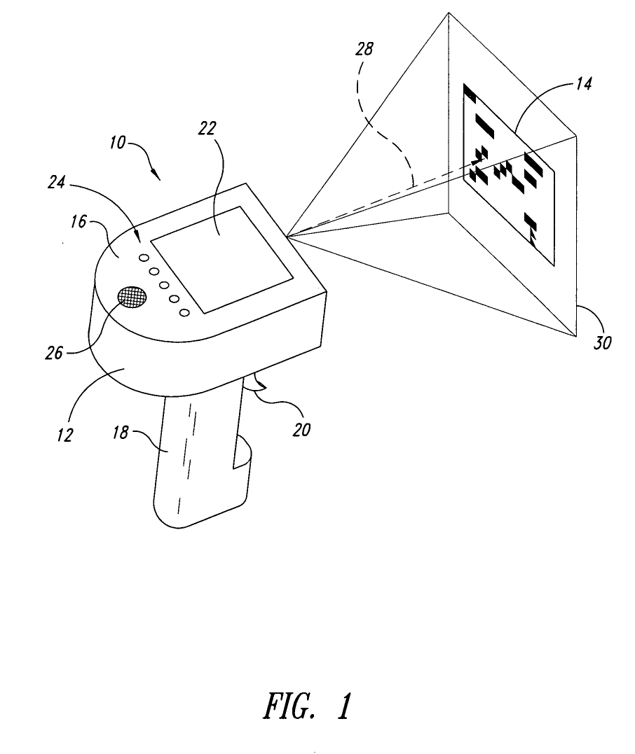

FIG. 1 shows a machine-readable symbol reader 10 including a housing 12 oriented to read a machine-readable symbol 14 according to one illustrated embodiment. The machine-readable symbol 14 may take any of a variety of forms, for example, one-dimensional or linear symbols such as barcode symbols, or two-dimensional symbols such as area or matrix code symbols, or stacked code symbols.

In particular, the machine-readable symbol reader 10 may include a head 16, handle 18, one or more user input devices such as user operable trigger 20. While illustrated as a pivoting type switch activator, the trigger may take any form of switch which may be activated by a user, including push buttons, rocker switches, toggle switches, and/or icons on touch-screens. The machine-readable symbol reader 10 may also include one or more user output devices such as a display 22, lights 24, and/or speaker 26. The display 22 may take the form of a liquid crystal display (LCD), which may take the form of a touch-screen display, operable to enter user input. The machine-readable symbol reader 10 is operable to provide an aiming beam 28. The machine-readable symbol reader 10 may also be operable to provide acquisition lighting, which may, for example encompass flood illumination 30. Alternatively, or additionally, the machine-readable symbol reader 10 may rely on ambient lighting.

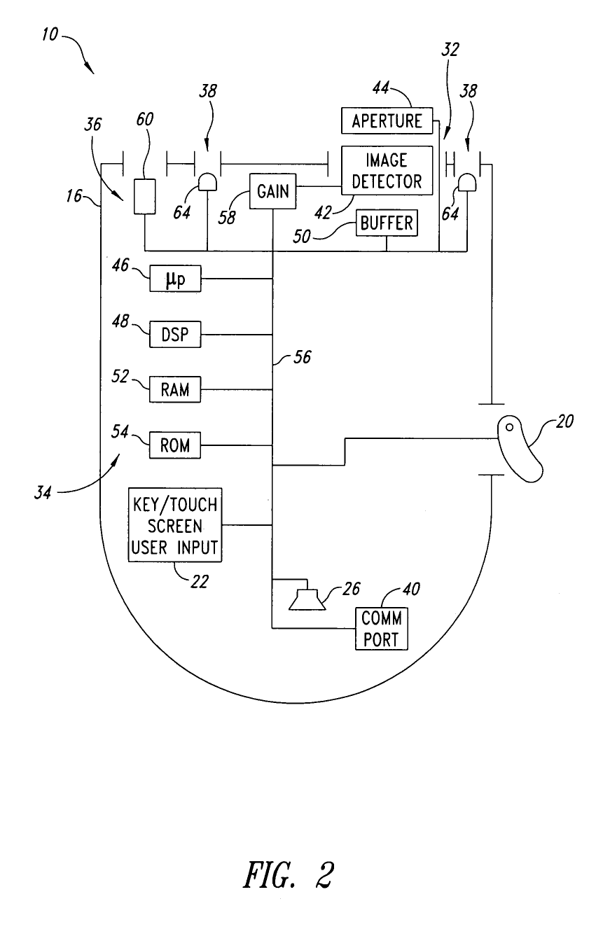

FIG. 2 shows the machine-readable symbol reader 10 in further detail. The machine-readable symbol reader 10 includes an imaging subsystem 32, control subsystem 34, aiming subsystem 36, and optionally an illumination subsystem 38. The machine-readable symbol reader 10 may also include a communications port 40 for providing communications with one or more external devices, systems, and/or networks.

The imaging subsystem 32 includes an image detector 42 and aperture 44. The image detector 42 is positioned in the housing 12 to receive light returned from the machine-readable symbol 14, the returned light being modulated by information encoded in the machine-readable symbol 14. The image detector 42 may take a variety of forms, for example a one-dimensional or a two-dimensional array of charge coupled devices (CCDs). The aperture 44 may be fixed, or may be manually and/or automatically adjustable.

The control subsystem 34 comprises one or more controllers, one or more memories, and one or more buses coupling the various elements of the control subsystem 34 with the imaging subsystem 32, aiming subsystem 36, and, optionally, the illumination subsystem 38, according to the illustrated embodiment.

The controllers 28 can take a variety of forms, for example one or more microprocessors 46, Digital Signal Processors (DSPs) 48, Field Programmable Gate Arrays (FPGAs), and/or Application-Specific Integrated Circuits (ASICs). An example of a suitable controller that can be used with the symbol reader 10 is described in detail in U.S. Pat. No. 6,618,162 filed on Jan. 26, 1999.

Likewise, the memories may take a variety of forms, for example, one or more buffers 50, registers (not shown), random access memories (RAMs) 52, and/or read only memories (ROMs) 54. The buffer 50 may temporarily store the image data received from the image detector 42 until the DSP 48 is ready to process the image data. Typically, the ROM 54 will persistently store instructions and/or data executable by the microprocessor and/or DSP 46, 48. Typically, the RAM 52 will dynamically store instructions and/or data for use by the microprocessor and/or DSP 46, 48.

Although illustrated in FIG. 2 as a single bus 56 for sake of clarity, the bus 56 may include one or more separate buses such as communications buses, data buses and/or power buses. The control subsystem 34 may further include a gain control circuit 58, coupled to control the gain of the image detector 42.

The aiming subsystem 36 may include one or more light sources 60, for example a laser source such as a silicon diode laser, or a light emitting diode (LED), operable to produce an aiming beam 28 (FIG. 1) with wavelengths in the visible portion of the electromagnetic spectrum. The aiming subsystem 36 may also include an aiming mechanism including one or more optical components such as stationary or moveable lenses, mirrors, reflectors, and/or prisms.

The illumination subsystem 38 includes one or more light sources 62, for example, one or more LEDs, operable to produce light in a portion of the electromagnetic spectrum in which the imaging will occur. For example, the LEDs may produce light in the visible or near infrared portions of the electromagnetic spectrum, or in a portion of the electromagnetic spectrum selected to excite the material forming the machine-readable symbol 14 (FIG. 1).

In operation, the controllers 46, 48 receive signals over bus 38, process the received signals, and provide control signals over the bus 38 to operate the various subsystems. For example, the DSP 48 may receive image data from the image detector for processing. The microprocessor 46 may executed a program or routine to determine whether to activate the aiming subsystem 36 and/or illumination subsystem 38 based, for example, on the ability of the DSP 48 to decode captured image data and/or based on the operational condition of a switch associated with the trigger 20. The microprocessor 46 may produce control signals to control the aiming subsystem 36 and/or illumination subsystem 38 accordingly.

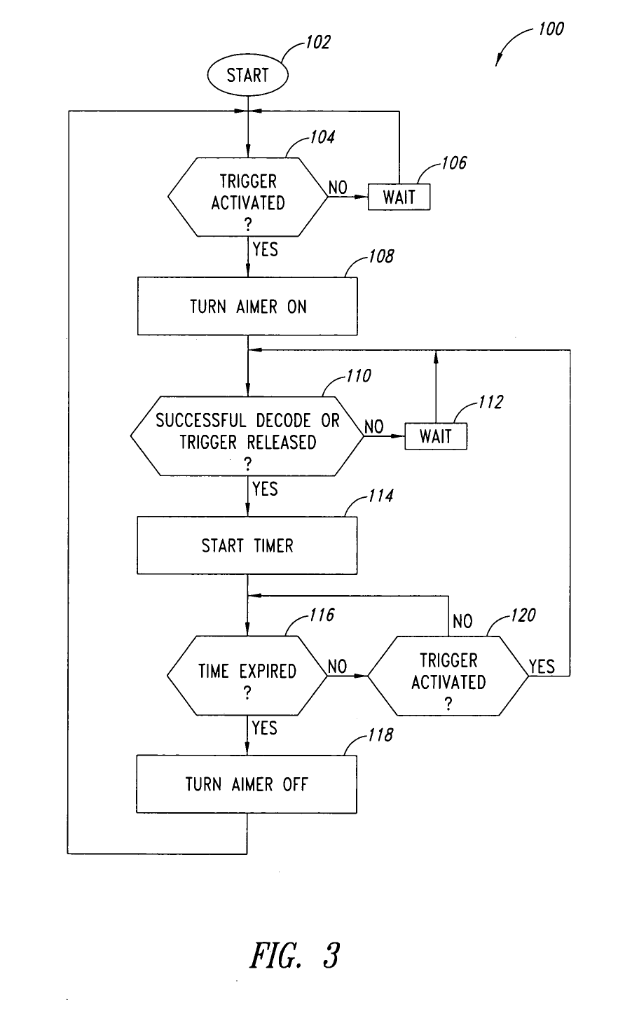

FIG. 3 shows a method 100 of operating the machine-readable symbol reader 10 (FIGS. 1 and 2) according to one illustrated embodiment, starting at 102.

At 104, the control subsystem 34 determines whether the user input device has been activated or selected. For example, the control subsystem 34 may determine whether the trigger 20 has been activated or pressed. If the user input device has not been activated or selected, the control subsystem 34 performs a wait loop at 106. If the user input device has been activated or selected, the control subsystem 34 operates the aimer subsystem at 108. For example, the control subsystem 34 places the light source 60 into an ON state to produce a visible aiming beam 28 (FIG. 1), thereby projecting the visible aiming beam 28 from the housing 12 toward the target 14.

At 110, the control subsystem 34 determines whether a decode of image data is successful or whether the user input device (e.g., trigger 20) has been released. If neither condition is TRUE, the control subsystem 34 performs a wait loop at 112. If at least one of the conditions is TRUE, the control subsystem 34 starts a timer at 114.

At 116, the control subsystem 34 determines whether the time counted by the timer has exceeded a threshold time out condition. The threshold time out condition may be user configurable. For example, an API (applications programming interface) may be used to enable/disable the “sticky” aimer and to set the timeout (in milliseconds). If the time exceeds the threshold time out condition, the control subsystem deactivates the aiming subsystem at 118, for example placing the light source 60 in an OFF state to stop producing the visible aiming beam, and control returns to 104. If the timer does not exceed the threshold time out condition, the control subsystem 34 passes control to 120. At 120, the control subsystem 34 determines whether the user input device is activated. For example, the control subsystem 34 determines whether the trigger 20 is depressed or otherwise selected. If the user input device is not activated, control returns to 116, otherwise control returns to 110.

As described above, the user or operator is thus able to aim the machine-readable symbol reader 10 at another machine-readable symbol target. If the sticky aimer time interval has not elapsed, and the scan trigger is pressed, such further machine-readable symbol target can be captured and decoded. Thus, after a successful decode, the sticky aimer is ON and the time out thread is notified that it should begin its wait period (i.e., 112). If the trigger 20 is pressed or otherwise activated before the time out expires (i.e., 116), the sticky aimer is immediately turned OFF and the normal decode process occurs. If the time out period expires, the sticky aimer is turned OFF by the timeout thread (i.e., 118), and the thread goes inactive until it is notified that another timeout period has begun.

The following discussion explains some of the options for utilization of the sticky aimer, and various advantages obtained, with a commercially available two-dimensional machine-readable symbol reader such as an imager, having, for example, a line type preamble line type aiming beam and a line type sticky aimer beam 28, and, for example an area type or flood LED illumination for use when ambient light does not provide the desired degree of illumination of the target machine-readable symbol 14.

One element in machine-readable symbol reader 10 optimization is aiming. Obviously, it is advantageous that the images sent to be decoded contain complete machine-readable symbols. No matter how fast the decoding processor, if there is not a complete machine-readable symbol in the image, the decoding processor will waste time trying to decode something that isn't there. In addition, one must remember, that typically, flashing illumination LEDs and the steady aimer beam are not both ON at the same time. Therefore, it is important that the setting for the aimer beam are adjusted to generate the response time required by the user.

First consider what happens when the user presses the scan trigger 20 on the machine-readable symbol reader 10. It would normally be desirable for the machine-readable symbol reader 10 to immediately capture an image in order to feed the resulting image data to the decoder (e.g., DSP 48 or microprocessor 46). However, if the LED illumination has been selected as the light mode, the reader 10 must first illuminate the machine-readable symbol in order to capture the image. This means that the aiming subsystem is not ON, and therefore the user is not able to precisely aim the reader 10.

There are two possible solutions to this dilemma, and these solutions are encapsulated in two machine-readable symbol reader configuration settings: Preamble Aimer Setting and Sticky Aimer Setting.

Preamble Aimer Setting

This reader configuration setting defines how long the preamble aiming beam will be turned ON before the first image is captured for the decoding. This can be thought of as a delay between the time the user presses the scan trigger 20 and the time the first image is fed to the decoding processor 48, 46. During this delay, the preamble aiming beam is ON and the light sources 62 of the illumination subsystem 38 are OFF.

The trade-off for this reader configuration setting is between the user's ability to make use of the preamble aiming beam and the amount of time it takes to decode a machine-readable symbol 14. For example, if the duration of the preamble aiming beam is set to 1000 ms, the preamble aiming beam will be left on for an entire second before any attempt is made to capture an image to be decoded. If after the one second is up, the image detector 42 captures an image and processor 48, 46 decodes the image data in 60 ms., the decode time is 1060 ms.—as opposed to 60 ms if the duration of the preamble aiming beam was zero milliseconds (or off). Although a second may not sound like a long time to decode a machine-readable symbol 14, in terms of user experience it can seem like forever. In addition, if the first image that is captured cannot be decoded and the user attempts another machine-readable symbol, this delay will be repeated for another 1000 ms. on the next image. This process can result in a deplorable user experience. Often it is better to disable the preamble Aiming beam, for example by a setting the duration to zero, because the potential for the negative trade-off often outweighs the benefits.

Sticky Aimer Setting

The Sticky Aimer is a setting on the machine-readable symbol reader 10 that causes the aimer beam to stay ON for an extended period of time after a machine-readable symbol 14 (FIG. 1) is decoded or after the scan trigger 20 is released. This is very useful if the user is reading multiple machine-readable symbols in a short amount of time, since the aimer will be fully illuminated for the subsequent machine-readable symbols even before the user presses the scan trigger 20 to start decoding. For example, the user can decode the first machine-readable symbol 14 as usual and then release the trigger. If the Sticky Aimer is enabled, the aiming beam 28 will turn ON as soon as the prior machine-readable symbol 14 has been decoded, even though the user has not pressed the scan trigger 20. The user can now aim at the next machine-readable symbol prior to pressing the scan trigger 20.

This not only makes it easier to aim the reader 10 in highly repetitive applications, but also prevents an erroneous machine-readable symbol from being decoded during the aiming process. If the scan trigger 20 is not pressed within a specified amount of time, the Sticky Aimer will automatically turn the aiming beam 28 OFF. The Sticky Aimer timeout period is user definable and can be fairly long if the user desires such. The tradeoff is battery usage, as the light sources 60 (FIG. 2) of the aiming subsystem 36 will draw more power if left ON than if turned OFF. A suitable default timeout period may be approximately one second. For applications requiring rapid succession decodes, the Sticky Aimer can actually give the appearance that the aiming beam 28 is ON almost constantly, while in reality it is ON no longer than if the Sticky Aimer was disabled. This results in a much more intuitive user experience. This approach can also eliminate the need for dual triggers or dual function/dual position triggers.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein can be applied to other machine-readable symbol reader, not necessarily the exemplary machine-readable symbol generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. provisional patent application Ser. No. 60/577,451, filed Jun. 5, 2004, are incorporated herein by reference, in their entirety. Aspects of the invention can be modified, if necessary, to employ systems, circuits and concepts of the various patents, applications and publications to provide yet further embodiments of the invention.

These and other changes can be made in light of the above-detailed description. In general, in the following claims, the terms used should not be construed to limit the invention to the specific embodiments disclosed in the specification and the claims, but should be construed to include all machine-readable symbol readers, methods of operating machine-readable symbol readers and articles for operating the same that operated in accordance with the claims. Accordingly, the invention is not limited by the disclosure, but instead its scope is to be determined entirely by the following claims.

1. A method of operating a machine-readable symbol reader to read machine-readable symbols, the method comprising:
projecting an aiming beam from the machine-readable symbol reader in a direction generally aligned with a field-of-view of the machine-readable symbol reader;
determining whether an elapsed time following a successful decoding of an acquired first machine-readable symbol exceeds an elapsed time threshold; and
continually projecting the aiming beam from the machine-readable symbol reader until the elapsed time is determined to exceed the elapsed time threshold.

2. The method of claim 1, further comprising:
acquiring the first machine-readable symbol; and
attempting a decoding of the acquired first machine-readable symbol before determining whether the elapsed time following the successful decoding of the acquired first machine-readable symbol exceeds the elapsed time threshold.

3. The method of claim 2, further comprising:
acquiring a second machine-readable symbol after determining whether the elapsed time following the successful decoding of the acquired first machine-readable symbol exceeds the elapsed time threshold;
attempting a decoding of the acquired second machine-readable symbol;
determining whether an elapsed time following a successful decoding of the acquired second machine-readable symbol exceeds the elapsed time threshold; and
continually projecting the aiming beam from the machine-readable symbol reader until the elapsed time is determined to exceed the elapsed time threshold.

4. The method of claim 3, further comprising:
receiving a user input indicative of a command to acquire an electronic representation of an area encompassing at least a portion of the field-of-view of the machine-readable symbol reader, and wherein acquiring the second machine-readable symbol is in response to the received user input indicative of the command to acquire then electronic representation of the area.

5. The method of claim 4, further comprising:
receiving a user input indicative of a command to activate the aiming beam, wherein projecting the aiming beam from the machine-readable symbol reader is in response to the user input indicative of a command to activate the aiming beam.

6. The method of claim 5 wherein receiving a user input indicative of a command to activate the aiming beam comprises receiving a signal indicative of a first activation of a trigger, and wherein receiving a user input indicative of a command to acquire an electronic representation of an area comprises receiving a signal indicative of a second activation of the trigger.

7. The method of claim 1, further comprising:
setting the elapsed time threshold in response to a user input indicative of an elapsed time threshold value.

8. A processor-readable medium storing instructions for causing a processor to operate a machine-readable symbol reader to read machine-readable symbols, by:
projecting an aiming beam from the machine-readable symbol reader in a direction generally aligned with a field-of-view of the machine-readable symbol reader;
determining whether an elapsed time following a successful decoding of an acquired first machine-readable symbol exceeds an elapsed time threshold; and
continually projecting the aiming beam from the machine-readable symbol reader until the elapsed time is determined to exceed the elapsed time threshold.

9. The processor-readable medium of claim 8 wherein the instructions cause the processor to operate the machine-readable symbol reader, further by:
acquiring the first machine-readable symbol; and
attempting a decoding of the acquired first machine-readable symbol before determining whether the elapsed time following the successful decoding of the acquired first machine-readable symbol exceeds the elapsed time threshold.

10. The processor-readable medium of claim 9, wherein the instructions cause the processor to operate the machine-readable symbol reader, further by:
acquiring a second machine-readable symbol after determining whether the elapsed time following the successful decoding of the acquired first machine-readable symbol exceeds the elapsed time threshold;
attempting a decoding of the acquired second machine-readable symbol;
determining whether an elapsed time following a successful decoding of the acquired second machine-readable symbol exceeds the elapsed time threshold; and
continually projecting the aiming beam from the machine-readable symbol reader until the elapsed time is determined to exceed the elapsed time threshold.

11. The processor-readable medium of claim 8, wherein the instructions cause the processor to operate the machine-readable symbol reader, further by:
setting the elapsed time threshold in response to a user input indicative of an elapsed time threshold value.

12. A method of operating a machine-readable symbol reader to read machine-readable symbols, the method comprising:
in response to a first activation of a user input device, projecting an aiming beam from the machine-readable symbol reader in a direction generally aligned with a field-of-view of the machine-readable symbol reader;
acquiring a first machine-readable symbol in the field-of-view of the machine-readable symbol reader;
attempting to decode the acquired first machine-readable symbol;
determining that the attempt to decode the acquired first machine-readable symbol was successful;
determining whether an elapsed time following the successful decode of the acquired first machine-readable symbol exceeds an elapsed time threshold; and
projecting the aiming beam from the machine-readable symbol reader if it is determined that the elapsed time does not exceed the elapsed time threshold.

13. The method of claim 12, further comprising:
in response to a second activation of a user input device, acquiring a second machine-readable symbol in the field-of-view of the machine-readable symbol reader; and
attempting to decode of the acquired second machine-readable symbol.

14. The method of claim 13, further comprising:
determining that the attempt to decode the acquired second machine-readable symbol was successful;
determining whether an elapsed time following a successful decoding of the acquired second machine-readable symbol exceeds the elapsed time threshold; and
projecting the aiming beam from the machine-readable symbol reader if it is determined that the elapsed time does not exceed the elapsed time threshold.

15. The method of claim 13 wherein the field-of-view of the machine-readable symbol reader is repositioned between acquiring the first machine-readable symbol and acquiring the second machine-readable symbol.

16. The method of claim 12 wherein projecting the aiming beam from the machine-readable symbol reader if it is determined that the elapsed time does not exceed the elapsed time threshold comprises continuously projecting the aiming beam until the earlier of the elapsed time following the successful decode of the acquired first machine-readable symbol exceeds the elapsed time threshold or a second activation of a user input device.

17. The method of claim 12 wherein projecting an aiming beam from the machine-readable symbol reader in a direction generally aligned with a field-of-view of the machine-readable symbol reader continues while acquiring the first machine-readable symbol.

18. The method of claim 12 wherein acquiring the first machine-readable symbol comprises producing an electronic representation of at least a portion of the first machine-readable symbol via an array of charge coupled devices.

19. A machine-readable symbol reader operable to read machine-readable symbols, the machine-readable symbol reader comprising:
a housing;
an optoelectronic detector received in the housing and having a field-of-view extending from the housing;
an aiming subsystem carried by the housing an operable to selectively project an aiming beam from the machine-readable symbol reader in a direction generally aligned with the field-of-view of the optoelectronic detector;
a first trigger operable in response to a first activation to cause the aiming system to project the aiming beam from the machine-readable symbol reader and operable in response to a second activation while the aiming beam projects from the machine-readable symbol reader to cause the acquisition of an electronic representation of machine-readable symbols for decoding; and
a control subsystem received in the housing and coupled to control the aiming subsystem based at least in part on signals generated by the first and the second activation of the first trigger.

20. The machine-readable symbol reader of claim 19 wherein the control system is configured to:
determine whether an elapsed time following a successful decoding of an acquired first machine-readable symbol exceeds an elapsed time threshold; and
continually project the aiming beam from the machine-readable symbol reader until the elapsed time is determined to exceed the elapsed time threshold.
